(19) United States
(12) Patent Application Publication
(10) Pub. No.: US 2007/0168132 A1
(43) Pub. Date: Jul. 19, 2007

(54) WELLBORE COMMUNICATION SYSTEM AND METHOD

(75) Inventors: HAN YU, Sugar Land, TX (US); Loong H. Tam, Houston, TX (US); Adrian Cretoiu, Sugar Land, TX (US); Jason M. Harris, Richmond, TX (US); Vincent Ligotino, Cypress, TX (US); Remi Hutin, New Ulm, TX (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, SUGAR LAND, TX (US)

(21) Appl. No.: 11/278,712

(22) Filed: Apr. 5, 2006

Related U.S. Application Data
(60) Provisional application No. 60/678,578, filed on May 6, 2005.

(51) Int. Cl. G01V 1/40; G01V 3/18; G06F 19/00

(52) U.S. Cl. 702/6; 166/254.2

(57) ABSTRACT

A communication system is used to download data from a downhole tool. The system includes at least one removable memory unit positioned in the downhole tool, at least one surface computer for receiving data from the at least one memory unit and a communication link for transmitting data from the memory unit to the surface computer. The communication link may be a direct, hard-wired, wireless or optical link.

### REFERENCE TO RELATED APPLICATION

This application claims priority to U.S. Provisional Application Ser. No. 60/678,578, filed on May 6, 2005 and entitled “Wellbore Communication System and Method.”

### BACKGROUND OF THE INVENTION

1. Field of the Invention

The present invention relates generally to communication systems for wellbore operations. More specifically, the present invention relates to communication systems for transferring data from a downhole tool to a surface computer.

2. Background of the Related Art

The harvesting of hydrocarbons from subterranean formations involves the drilling of wellbores into the earth. To create the wellbore, a downhole drilling tool is suspended from a drilling rig and advanced into the earth via a drill string. During the drilling operation, it is desirable to obtain information about the downhole conditions. Such information is useful, for example, in locating desirable formations, preventing potential problems and improving the drilling operation.

Information may be collected by the downhole tools during the drilling operation. Information may also be collected by deploying additional tools, such as a wireline formation evaluation tool, into the wellbore to gather information. In some cases, the tools may transmit information to the surface via communication links between the downhole tool and the surface, such as a wireline cable. In other cases, information is stored in the downhole tool and downloaded therefrom once the tool is retrieved at the surface. For example, U.S. Pat. No. 6,831,571, describes a data dump probe that is used to download data from a downhole tool to a surface computer.

Despite such advances in data transfer systems, there remains a need to provide techniques for efficient and effective transfer of data from the downhole tool to a surface computer. It is desirable that such a system provide a flexible and efficient means for transferring data from the tool to a surface computer. It is further desirable that such a system provide one or more of the following, among others: a wireless link, a hardwired link, memory storage, adapters, options for additional links, power sources, and processors. A need therefore exists for a communication system with one or more of these advanced capabilities.

### SUMMARY OF THE INVENTION

The present invention relates to a communication system used for downloading data from a downhole tool. The system includes at least one removable memory unit positioned in the downhole tool, at least one surface computer for receiving data from the memory unit and a communication link for transmitting data from the memory unit to the surface computer. The communication link may be a direct, hard-wired, wireless or optical link.

In another aspect, the invention relates to a communication system for downloading data from a downhole tool. The system includes at least one memory unit positioned in the downhole tool, at least one data storage device adapted to receive data from the memory unit, at least one surface computer for receiving data from the data storage device and a communication link for transmitting data from the memory unit to the surface computer. The memory unit is capable of storing data collected by the downhole tool.

In another aspect, the invention relates to a method of downloading data from a downhole tool. The method involves establishing a wireless communication link between the memory unit of the downhole tool and the surface computer and transferring data from the downhole tool to the surface computer.

In yet another aspect, the invention relates to a method of downloading data from a downhole tool. The method involves removing at least one memory unit from the downhole tool, establishing a communication link between the memory unit of the downhole tool and the surface computer and transferring data from the downhole tool to the surface computer.

The method of may involve operably connecting a data storage device to the memory unit of the downhole tool and establishing a wireless communication link between the data storage device of the downhole tool and the surface computer.

The method may involve operably connecting an adapter to at least one memory unit of the downhole tool and establishing a wireless communication link between the at least one memory.

Other aspects and advantages of the invention will be apparent from the following description and the appended claims.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a wellsite including a surface computer and a downhole drilling tool suspended from a drilling rig and into a wellbore.

FIG. 2 is a schematic view of two downhole drilling tools retrieved to the surface for communication with a surface computer.

FIG. 3 is a schematic view of a portion of the downhole drilling tool of FIG. 1 in communication with multiple surface computers, the downhole drilling tool having a communication system therein.

FIG. 4A is a schematic view of the downhole tool of FIG. 4 having at least one removable memory unit.

FIG. 4B is a schematic view of the removable memory unit of FIG. 4A in communication with a surface computer.

FIG. 5 is a schematic view of the downhole tool of FIG. 4 in communication with a surface computer via a data storage device.

FIG. 6 is a schematic view of the downhole tool of FIG. 4 in communication with a surface computer via a linking system.

### DETAILED DESCRIPTION OF THE INVENTION

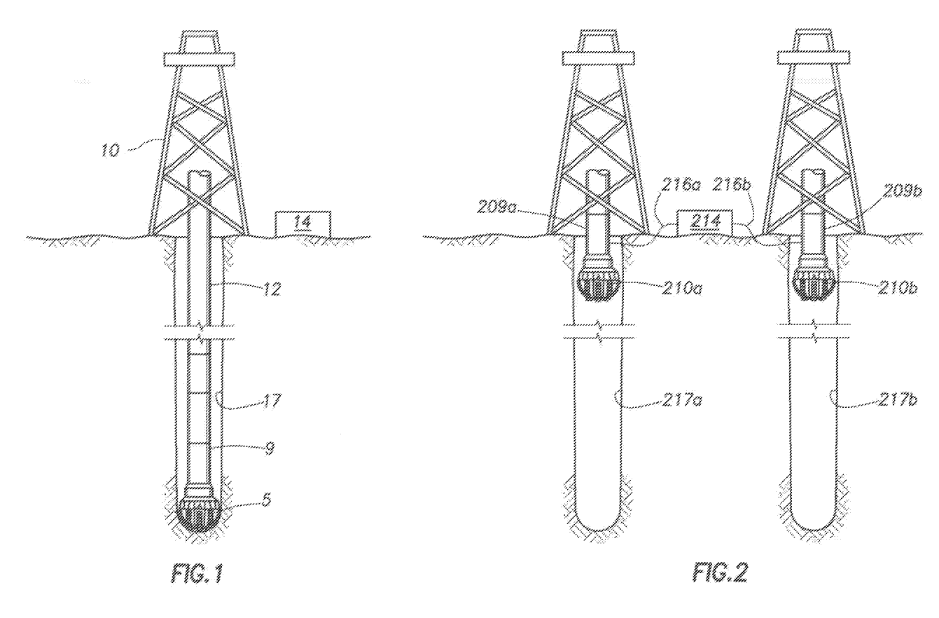

FIG. 1 is a schematic diagram of a wellsite with a drilling rig 10 and a drill string 12. The drill string is suspended from the rig 10 and into a wellbore 17. The drill string is connected to a bottom hole assembly (BHA) 9 and a drill bit 5 at a lower end thereof. A surface computer 14 is positioned at the surface and used to control operations at the wellsite. The BHA 9 is provided with while drilling systems (not shown), sometimes referred to as logging while drilling or measurement while drilling system, used to collect downhole data. The data may be transmitted to the surface while the tool is positioned in the wellbore. Data may also be collected and stored in the tool for retrieval at the surface.

FIG. 2 shows drilling tools 210a and 210b retrieved from wellbores 217a, 217b, respectively, to the surface for communication with a surface unit 214. A BHA 209a and 209b of each drilling tool is provided with a surface link 216a and 216b with the surface computer 214. While only two drilling tools are depicted in communication with one surface computer, it will be appreciated that one or more drilling tools may be in communication with one or more surface units.

The downhole tools 210a and 210b are depicted in FIG. 2 as having a communication link 216a, 216b, respectively, for communication with the surface computer. This communication link may be a hard-wired or physical, wireless, optical or other communication link. Examples of such communication links may include serial, USB, firewire, Ethernet, wireless, infrared, wifi, bluetooth, fiber optic, etc. A wireless link typically uses at least one transmitter, at least one receiver and at least two antennas. A receiver and/or a transmitter may be replaced by a more universal transceiver.

FIG. 3 shows a downhole tool 310 in communication with multiple surface computers 314a, 314b. The downhole tool 310 includes a while drilling system 318 including a sensor unit 319, a processor 320 and a memory unit 322. The senor unit may be any measurement system used in while drilling applications for gathering data, such as a resistivity system for measuring formation parameters. The data is processed using the processor 320 and stored in the memory unit 322.

At least a portion of the data collected in the memory unit may be transmitted to the surface computer. As shown in FIG. 3, the tool 310 may be placed in communication with one or more surface units 314a, 314b. One or more communication links 316a, 316b may be provided to establish communication between the downhole tool and the surface computer(s). The surface computer(s) may be at any location on or off the wellsite.

The memory unit 322 may be any memory storage device capable of collecting and storing data for later retrieval. For example, the memory unit interface to the surface computer may be serial, USB, firewire, Ethernet, wireless, infrared, wifi, bluetooth, fiber optic, etc.

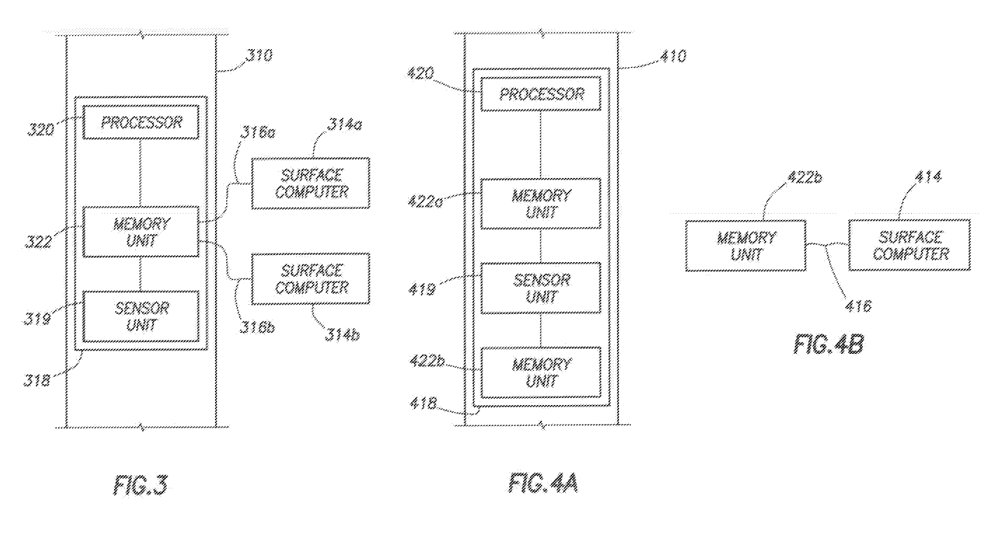

FIG. 4A and 4B show a downhole tool 410 in communication with a surface computer 414 via a removable memory unit 422b. FIG. 4A shows an alternate while drilling system 418 of the downhole tool 410. This while drilling system is provided with a processor 420, a sensor unit 419 and two memory units 422a, 422b. One or more memory units may be used, and one or more of these memory units may be removable for the downhole tool. As shown in FIG. 4B, removable memory unit 422b is removed from the downhole tool and placed in communication with surface computer 414 via communication link 416. The memory unit may then be reinserted into the downhole tool and deployed into the wellbore for further measurements.

FIG. 5 depicts a downhole tool 510 in communication with a surface computer 514 via a data storage device 530. The downhole tool has a while drilling system 518 including a processor 520, memory unit 522 and sensor unit 519. The data storage device 530 is placed in communication with the memory unit 522 of the downhole tool 510 via download link 532. Data is downloaded from the downhole tool 510 to the data storage device 530 via the download link 532. The data storage device may be any type of memory unit operably connectable to the downhole tool. For example, a conventional computer drive may be connected to the downhole tool. The download link 532 may be a direct link between the data storage device, a wired cable, a wireless link or other link capable of transferring data between the memory unit 522 and the data storage device. Preferably, the data storage device is a mobile system that provides for at least temporary storage of data for future download. Such devices include flash memory cards of various types and portable mini-hard disk drives. The data storage device is then operatively connected to surface computer 514 via surface link 516. For example, this link may be serial, USB, firewire, Ethernet, wireless, infrared, wifi, bluetooth, fiber optic, etc.

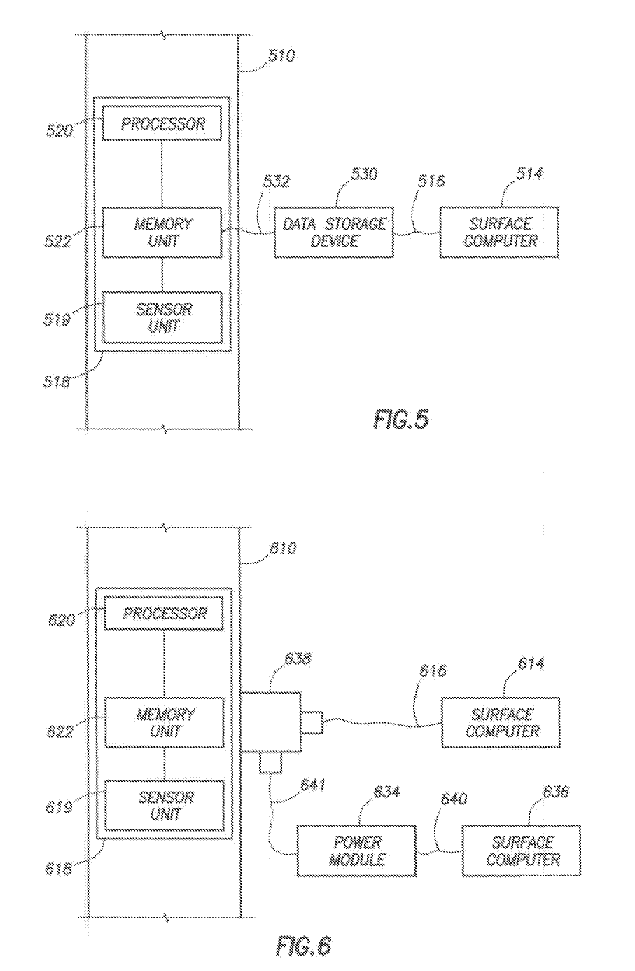

FIG. 6 depicts a downhole tool 610 having a while drilling system 618 in communication with a surface computer 614. The while drilling system includes a processor 620, a memory unit 622 and a sensor unit 619. An adapter 638 is connected to the tool to provide a means for connecting the surface computer 614 to the downhole tool. The adapter may also be used to connected a power source 636 and a power module 634 to the downhole tool. Surface link 616 connects the surface computer to the adapter 638. Power links 640 and 641 connect the power module and power source to the adapter 638.

The surface computer may be an Ethernet Based Computing Device (ECD) capable of performing all tool communication tasks at the rig site, such as configuring the tool, checking the tool status, and dumping the tool recording memory. The ECD can be, for example, a handheld computing device or PDA, a laptop, desktop or tablet PC. The ECD may be provided with large data storage with high-speed access rate compatible with the Ethernet communication speed (in excess of 20 Mbps). A commercially available ECD with integrated Ethernet (wireless or not) may be used.

The ECD may use Ethernet as the communication protocol. The communication can be done, for example, either through an oilfield approved Ethernet CAT5 cable or via wireless Ethernet interface such as Wi-Fi or IEEE standard 802:11 for wireless networking and variants.

The power source may use AC or DC power. Typically, downhole tools use DC, so it may be desirable to convert the power to DC. Additionally, the power source may eliminate the use of long distance cables, elimination of a ground loop, use of a single ground unit, elimination of the requirement of optical isolation and reduction of voltage drop along the cable. Transient protections may still be provided for plug and play type devices.

The power module 634 may be used to provide DC voltage power. The adapter 638 may be a Universal ROP (Read-Out-Port) Adapter (UROPA) with internal circuitry to convert the input power to the desired voltage, for example, for use with an EIA-232/EIA-485 converter circuit. Manual or automatic switches may be provided to control the power.

It will be understood from the foregoing description that various modifications and changes may be made in the preferred and alternative embodiments of the present invention without departing from its true spirit. For example, while the sensor is described in at least some aspects as being a pressure sensor, it will be appreciated that any type of sensor may be used, such as temperature, density, flow rate, etc.

This description is intended for purposes of illustration only and should not be constructed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

What is claimed is:

1. A communication system for downloading data from a downhole tool, comprising:
at least one removable memory unit positioned in said downhole tool, said memory unit being capable of storing data collected by said downhole tool;
at least one surface computer for receiving data from said memory unit; and
a communication link for transmitting data from said memory unit to said surface computer.

2. The communication system of claim 1, wherein said communication link is selected from among the group of communications link including serial, USB, firewire, Ethernet, wireless, infrared, wifi, bluetooth, and fiber optic links.

3. The communication system of claim 1, further comprising a data storage device adapted to receive data from said memory unit for transfer to said surface computer.

4. The communication system of claim 1 further comprising an adapter for coupling said communication link to said downhole tool.

5. The communication system of claim 4, further comprising a power module and a power source operatively coupled to said adapter.

6. A communication system for downloading data from a downhole tool, comprising:
at least one memory unit positioned in said downhole tool, said memory unit being capable of storing data collected by said downhole tool;
at least one data storage device adapted to receive data from said memory unit;
at least one surface computer for receiving data from said data storage device, and
a communication link for transmitting data from said memory unit to said surface computer.

7. The communication system of claim 6, wherein said communication link is selected from among the group of communications links including serial, USB, firewire, Ethernet, wireless, infrared, wifi, bluetooth, and fiber optic links.

8. The communication system of claim 6, wherein said memory unit is removable from said downhole tool.

9. The communication system of claim 6 further comprising an adapter for coupling said communication link to said downhole tool.

10. The communication system of claim 9, further comprising a power module and a power source operatively coupled to said adapter.

11. A method of downloading data from a downhole tool having at least one memory unit, comprising the steps of;
establishing a wireless communication link between said memory unit and at least one surface computer; and
transferring data from said downhole tool to said surface computer.

12. The method of claim 11 further including the step of transferring data from said downhole tool to a second surface computer.

13. The method of claim 11 further comprising:
operably coupling a data storage device to said memory unit of said downhole tool; and
establishing a wireless communication link between said data storage device and said surface computer.

14. The method of claim 13 further including the step of transferring data from said data storage device to said surface computer.

15. The method of claim 13 further including the step of transferring data from said downhole tool to a second computer.

16. The method of claim 11 further comprising:
operably coupling an adapter to said memory unit; and
establishing a wireless communication link between said memory unit and said surface computer via said adapter.

17. The method of claim 16 further including the step of transferring data from said downhole tool to a second computer.

18. A method of downloading data from a downhole tool having at least one memory unit, comprising the steps of;
removing said memory unit from said downhole tool;
establishing a communication link between said memory unit and said surface computer; and
transferring data from said downhole tool to said surface computer.

19. The method of claim 18 further including the step of transferring data from said memory unit to said surface computer.

20. The method of claim 18 further including the step of transferring data from said downhole tool to a second computer.
